(19) United States
(12) Patent Application Publication
(10) Pub. No.: US 2004/0207724 A1
(43) Pub. Date: Oct. 21, 2004

(54) System and method for real time playback of conferencing streams

(75) Inventors: Richard Crouch, San Jose, CA (US); Timothy Miller, Boca Raton, FL (US); Florian Patrick Nierhaus, Sunnyvale, CA (US)

Correspondence Address: Siemens Corporation, Attn: Elsa Keller, Legal Administrator, Intellectual Property Department, 186 Wood Avenue South, Iselin, NJ, 08830, US

(73) Assignee: Siemens Information and communication Networks, Inc.

(21) Appl. No.: 10/417,549

(22) Filed: Apr. 17, 2003

(51) Int. Cl. H04N 7/14; H04N 15/00; H04N 13/04

(52) U.S. Cl. 348/14.09; 348/60

(57) ABSTRACT

A telecommunications system includes a conferencing server (104, 106), a recording server (114) operably coupled to the conferencing server; and one or more telecommunications clients (110). The telecommunications clients (110) can use the conferencing server to supervise conversations between two or more of the parties. The recording server (114) is used to record conversations among the parties and store them as one or more digital files. The telecommunications clients (110) may further be provided with user interfaces (112) that allow control of the recording server (114) for real-time playback during a conversation. The user interface allows the user to control backup; normal speed forward; fast forward; back to beginning; and go to end (i.e., back to real-time output for the call).

### FIELD OF THE INVENTION

The present invention relates to telecommunications systems and, in particular, to an improved system and method for multimedia teleconferencing system management.

### BACKGROUND OF THE INVENTION

Multimedia conferencing, especially voice and video conferencing, is becoming an increasingly important feature of the work environment. The need for such conferencing systems has played a role in the development of Internet Protocol (IP) and, particularly, telephony over local area network (ToL) systems. In ToL systems, telephone features and access to the external telephone network are provided on a user's local area network under supervision of a telephone server, rather than on a separate Private Branch Exchange (PBX) based system. Exemplary ToL systems include the systems based on the Session Initiation Protocol (SIP) and the Recommendation H.323 set of protocols. In such systems, a device known as a Multipoint Control Unit may (MCU) be provided to supervise a conference call among three or more participants.

During such a conference and, in fact, during a two-party call as well, one participant may not clearly hear what is spoken by other parties in the conversation. In such a case, the participant may request that the statement be repeated. However, especially during a multiparty conference, this can be disruptive to the speaker's flow and the conversation. Alternatively, if the conversation is being recorded, the participant could review the conference at a later time. This, however, does not allow the participant to interact with other users or request clarifications and the like. If the participant is recording the conference locally, he could rewind and play back the missed portion, but the typical recording device does not maintain simultaneous record and playback modes. Thus, while listening to a missed portion of the conversation, the participant would not be able to record the ongoing real time conversation.

### SUMMARY OF THE INVENTION

These and other drawbacks in the prior art are overcome in large part by a system and method according to embodiments of the present invention.

A telecommunications system according to an embodiment of the present invention includes a conferencing server, a recording server operably coupled to the conferencing server; and one or more telecommunications clients. The telecommunications clients can use the conferencing server to supervise conversations between two or more of the parties. The recording server is used to record conversations among the parties and store them as one or more digital files. The telecommunications clients may further be provided with user interfaces that allow control of the recording server for real-time playback during a conversation. The user interface allows the user to control backup; normal speed forward; fast forward; back to beginning; and go to end (i.e., back to real-time output for the call.).

A telecommunications client according to an embodiment of the present invention includes a telephony client and a recording interface client. In one embodiment, the telephony client is a telephony-over-LAN client. The recording interface client provides a signaling connection to a recording server during a telephone call. The recording interface client allows the user to interact with the recording server to control playback of a conversation while the conversation is ongoing.

A method according to an embodiment of the present invention includes establishing a multiparty conference via a multipoint control unit (MCU); mixing media streams for the conference at the MCU; providing a mixed media stream from the MCU to a recording server for saving as one or more media files; and switching between sending a real-time media stream to a party to the conference and a recorded media stream. In certain embodiments, the recorded media stream is played back at a higher speed than it was recorded to allow the party to play back part of a real-time session and return to listening in real time without having to skip over part of the conversation.

A better understanding of these and other specific embodiments of the invention is obtained when the following detailed description is considered in conjunction with the following drawings.

### BRIEF DESCRIPTION OF THE DRAWINGS

FIG. 1 is a block diagram of a telecommunications system according to an embodiment of the present invention.

FIG. 2A and FIG. 2B illustrate schematically operation of an embodiment of the present invention.

FIG. 3 is a block diagram of an exemplary recording server according to an embodiment of the present invention.

FIG. 4 is a block diagram of an exemplary multipoint control unit according to an embodiment of the present invention.

FIG. 5 is a diagram illustrating an exemplary recording interface client according to an embodiment of the present invention.

FIG. 6 is a signaling diagram illustrating operation of an embodiment of the present invention;

FIG. 7 is a diagram illustrating recording compression playback according to an embodiment of the present invention.

FIG. 8A-FIG. 8B illustrate recording setup according to an embodiment of the present invention.

### DETAILED DESCRIPTION OF EMBODIMENTS OF THE INVENTION

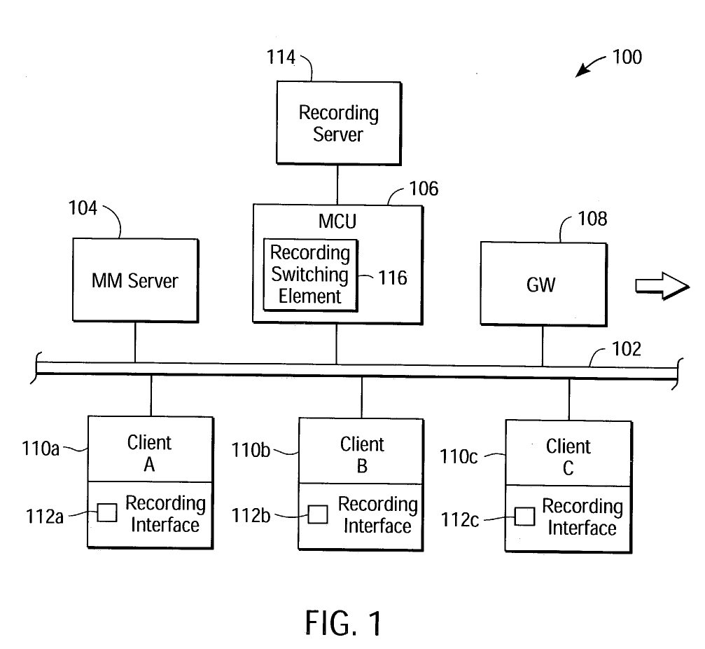

Turning now to the drawings and, with particular attention to FIG. 1, a diagram illustrating a telecommunications system according to an embodiment of the present invention is shown. The telecommunications system 100 includes a packet network 102, such as a local area network, a multimedia server 104, a multipoint control unit 106, a gateway 108, and a plurality of network clients 110a-110n. The packet network 102 may be embodied as a wired or wireless network. In certain embodiments, the network 102 supports Internet Protocol telephony, also known as telephony-over-LAN. Examples of IP telephony protocols include the H.323 Recommendation suite of protocols and the Session Initiation Protocol (SIP). The gateway 108 provides a gateway to an external network, such as the Internet or the Public Switched Telephone network.

The multipoint control unit 106 coordinates multimedia conferencing. In particular, in certain embodiments, the MCU 106 handles call signaling, mixes audio and video streams, performs transcoding between different codecs, and re-transmits the results to all parties to the conference. In addition, as will be explained in greater detail below, the multipoint control unit 106 may include on or more recording switching units 116 for switching between transmitting “live” media streams and “recorded” media streams to a requesting client. In addition, as will be explained in greater detail below, a recording sever 114 according to embodiments of the present invention may be coupled to the multipoint control unit 106.

The multimedia server 104 can perform address translation from LAN aliases for terminals and gateways to IP or IPX addresses as well as bandwidth management. The multimedia server 104 may further be used for call routing and providing services such as Instant Messaging and presence services.

The network clients 110a-110n may be implemented as Internet Protocol (IP) telephony clients and embodied as wired or wireless LAN telephones or personal computers running telephony software and equipped with sound cards, microphone and speaker(s). In addition, the network clients 110a-110n may include recording interface clients 112a-112n according to embodiments of the present invention. As will be described in greater detail below, the network clients 110a-110n may use the recording interface clients 112a-112n to record calls that are established between themselves or coordinate conferences using the multipoint control unit 106. The recording interface clients 112a-112n may further be used to playback and interact with the recorded conversation(s) in real time.

It is noted that in other embodiments, the recording server 114 may couple directly to the packet network 102, or may be integrated with the multimedia server 104 or the multipoint control unit 106. Similarly, the MCU 106 and the multimedia server 104 may be integrated into a single unit. Thus, the figures are exemplary only.

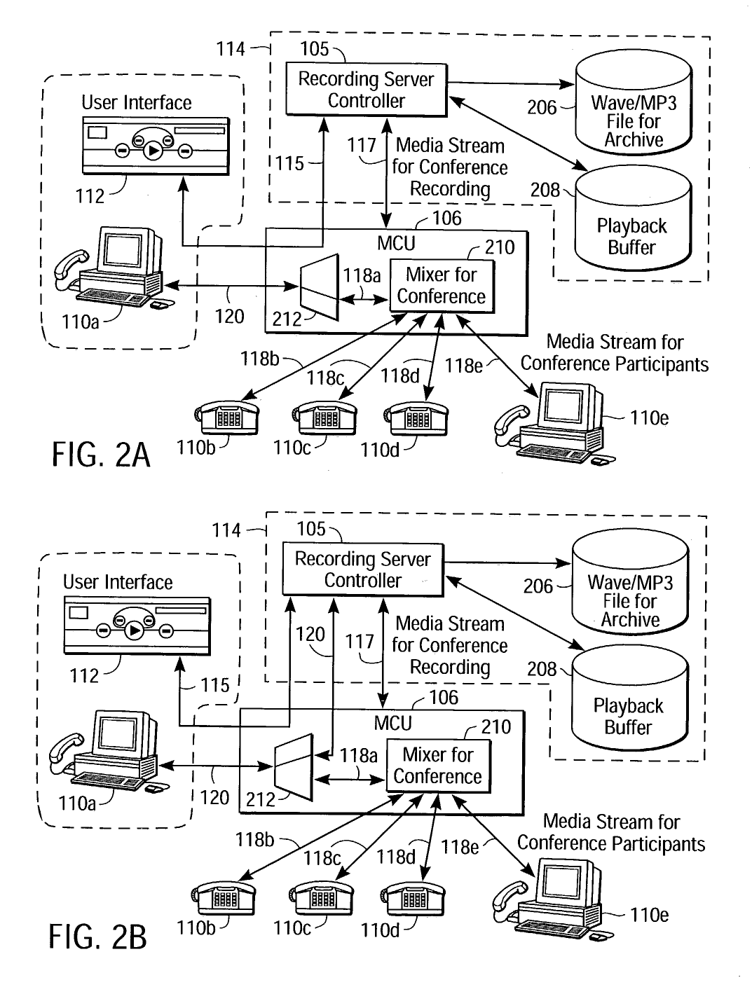

FIG. 2A and FIG. 2B schematically illustrate operation of an embodiment of the present invention. As shown in the example illustrated in FIG. 2A, five network clients 110a-110e are participating in a conference coordinated by the MCU 106. In the example illustrated, network client 110a is equipped with a recording user interface client 112 according to embodiments of the present invention. As noted above, the network client 110a can be embodied, for example, as a network telephone or as a telephony-equipped personal computer.

Also shown in FIG. 2A is recording server 114, which includes a controller 105, media file archive 206, and playback buffer 208. The MCU 106 includes a mixer 210 for mixing media streams and a switch 212, such as a multiplexer. As will be explained in greater detail below, the switch 212 is used to switch the media stream being received by the network client 110a between a live stream from the mixer 210 and a recorded stream from the recording server 114.

More particularly, the network clients' 110b-110e media streams 118b-118e are mixed at the MCU 106 by mixer 210. Typically, the media streams are implemented using Real Time Protocol (RTP), although other media protocols are contemplated. In standard operation, the media stream 118a is also provided via the switch 212 to the network client 110a. The mixer 210 provides a media stream 117 to the recording server 114 for storage in archive 206. In addition, the network client 110a and, particularly, its recording interface 112, may establish a recording control channel 115 with the recording server 114. In certain embodiments, this channel is via the MCU 106, which may also receive and act on the corresponding control signals. In other embodiments, the recording control channel 115 can be a direct channel between the client 110a and the recording server 114, bypassing the MCU 106. It is noted that several types of control connections could be established. For example, the connection could be an HTTP (hypertext transfer protocol) based connection using a Web-type interface. Alternatively, in band control signaling could be used, such as via DTMF or multifrequency tones.

As shown in FIG. 2B, the network client 110a can send one or more control signals over the channel 115 to the recording server 114 to access the recorded conversation. The MCU 106 then uses the switch 212 to switch the media stream being received by client 110a from the live stream 118a of FIG. 2A to a new media stream 120 received from the recording server 114. The recording server 114 accesses the recorded conversation, as specified in the control signals, i.e., accesses media files in memory 206, transfers one or more media files to the playback buffer 208, and provides it as a new media stream 120 to the MCU 106, which relays it to the client 110a. As noted above, the user has various options for controlling the recorded media stream, such as backup, normal speed forward, fast forward, go to beginning, and go to end. It is noted that, in addition to audio files, such media files may be video or other media or conferencing files. Thus, the present invention is not limited to audio conferences.

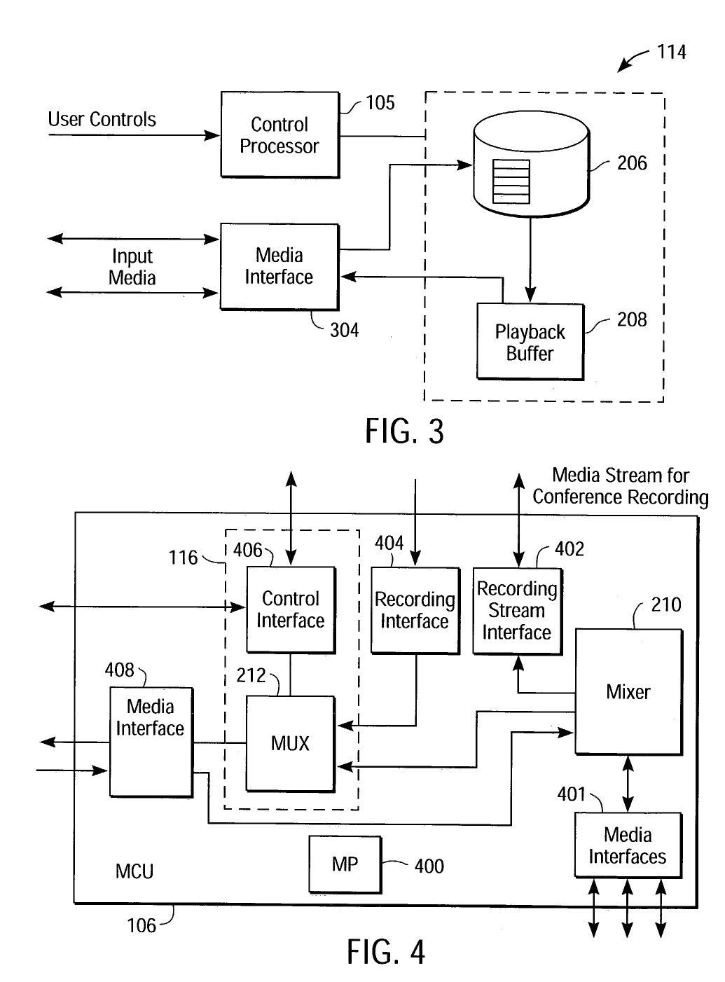

FIG. 3 is a block diagram of an exemplary recording server according to an embodiment of the present invention. As shown, the recording server 114 includes a control processor 105, an input media interface 304, file storage 206 and a playback buffer 208. The control processor 105 may be implemented, for example, as a microprocessor with suitable programming. The control processor 105 receives control inputs from the network client 110a that is equipped with a recording interface according to embodiments of the present invention. Input media streams, such as RTP audio and/or video, are received at the media interface 304. The media streams are indexed and stored as digital media files in archive 206 and are played back via playback buffer 208. Suitable formats include MP3 and .wav, though other digital media formats are contemplated. As will be explained in greater detail below, the control processor 105 receives commands for playback in one of a variety of playback modes. The control processor 105 accesses the archive 206 for the appropriate file(s), which are then buffered in the playback buffer for playback via the media interface 304. The media interface 304 then sets up a new media connection to the MCU 106 (FIG. 2B), which then relays the recorded media to the network client 110a. As noted above, the media interface 304 may implement a variety of multimedia over packet network protocols, such as H.323 or SIP, and may convert the digital file into a format suitable for transmission over the network. Typically, the underlying media stream is an RTP stream.

An exemplary multipoint control unit (MCU) 106 according to an embodiment of the present invention is shown in FIG. 4. Suitable base multipoint control units which may be adapted for use with embodiments of the present invention are available from a variety of manufacturers. As shown, the MCU 106 may include one or more multipoint processors 400 and mixer 210 and recording switching unit 116. The recording switching unit 116 includes switch 212 and control interface 406. Also shown are media interfaces 401, 408, a recording interface 402 and a recording transmit interface 404. It is noted that, while shown as discrete units, the various interfaces may be implemented as more or less integrated units. Furthermore, it is noted that more or fewer of the switches and interfaces may be provided as necessary.

The recording transmit interface 404 receives a recorded media stream from the recording server 104 and provides it to the switch 212. The media interfaces 401, 408 interface to the various network clients 110a-110n. The media interfaces thus receive individual media streams and provide them to the mixer 210; they further transmit the mixed media streams received from the mixer 210 to the network clients. The mixer 210 also provides a mixed media stream to the media interface 401 via the switch 212. The recording stream interface 402 may be generally similar to the media interfaces 401, though in typical operation would transmit a mixed media stream to the recording server 104.

The control interface 406 couples to receive control inputs from the network client 110a and to transmit commands to the recording server 104 and the switch 212. In response to these commands, the switch 212 is coupled to switch between media streams received from the mixer 210 and the recording transmit interface 404.

In typical operation, the multipoint controller 400 coordinates a multipoint conference using mixer 210, and transmits a media stream via the recording stream interface 402 to the recording server 104. The recording server 104 then records the conference. If one or more clients have recording interfaces, as determined, for example, during call setup and capability exchanges, their received mixed streams will be transmitted via a switch 212. In other embodiments, all streams may be provided via a switch 212. The control interface 406 then may receive one or more control signals from the recording interface equipped client; this causes the control interface to issue corresponding control commands to the recording server 104 and the switch 212. The MCU 106 then receives the recorded media stream via the recording transmit interface 404, which provides the stream to the switch 212. The control interface causes the switch 212 to switch its output from the mixer 210 to the recording receive interface 404. The resulting media stream is provided to the client via interface 408.

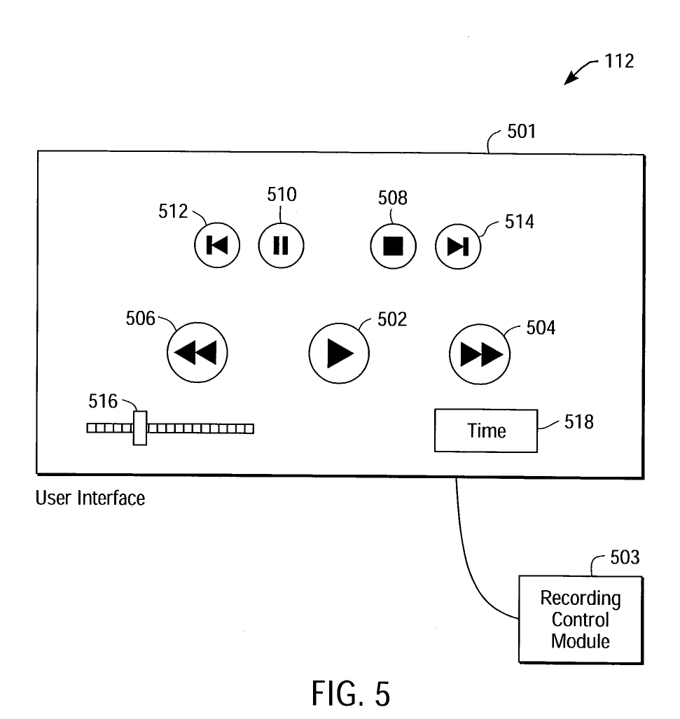

Turning now to FIG. 5, a block diagram illustrating an exemplary recording control system is shown. In the embodiment illustrated, the recording interface 112 includes a graphical user interface 501 and a recording control module 503. The recording control module 503 may be one or more software programs implemented on a microprocessor, such as a Pentium-type processor. The recording control module 503 receives inputs from the graphical user interface 501 and transmits them to the recording server 114. As noted above, in certain embodiments, the control signaling may be in the form of HTTP signaling via a web-type interface, though other signaling is also contemplated. In particular, the signaling may be call-related signaling or non-call-related signaling. Further, it is noted that in other embodiments, the interface functionality may be implemented using discrete buttons or key sequences. Thus, the figure is exemplary only.

As shown, graphical user interface 501 includes a plurality of playback controls. These can include Play 502, fast forward 504, fast reverse 506, stop 508, pause 510, go to beginning 512, and go to end 514. In addition, a slide control 516 may be used to set a particular point in a conversation the recording playback is to start; similarly, a time window 518 may be provided to receive a “go back” time before present at which the playback should begin.

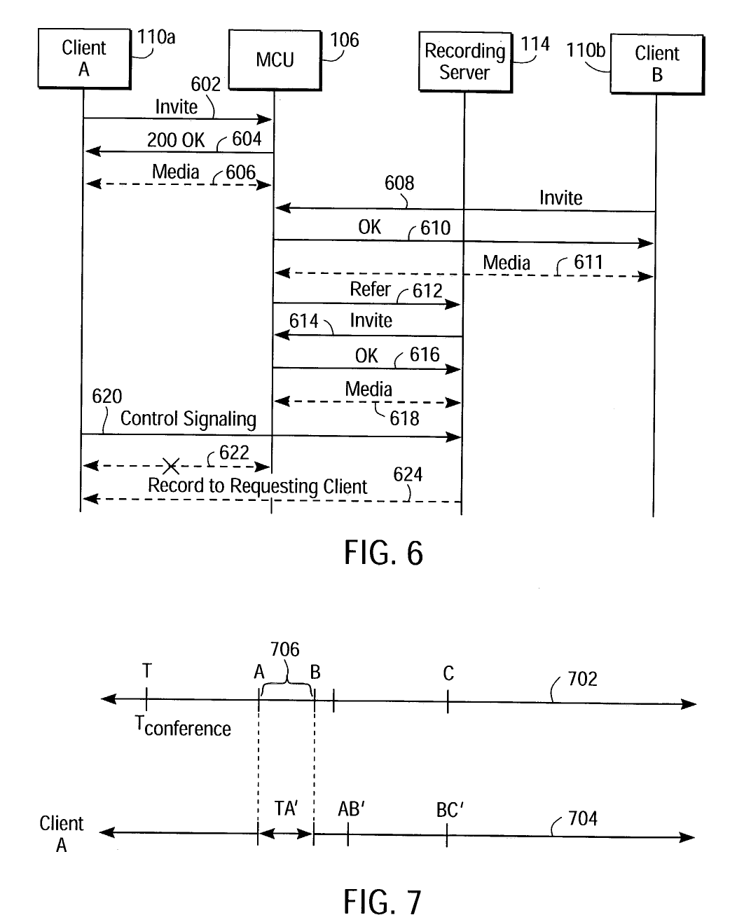

Turning now to FIG. 6, a signaling diagram illustrating operation of an embodiment of the present invention is shown. Shown are a client 110a, MCU 106, Recording Server 114, and client 110b. It is noted that, for clarity, only two participants to the conference are shown. The conference can similarly be extended to larger numbers of participants. Further, in the example illustrated, a Session Initiation Protocol (SIP) telephony-over-LAN environment is assumed. It is noted, however, that the teachings of the present invention are equally applicable to other ToL protocols, such as Recommendation H.323, and to other network configurations. At 602, the Client A 110a sends a SIP Invite request to the MCU 106. The Invite request can include a conference identifier and a request to record the conference. Alternatively, the request to record can be made later, during the actual conference. At 604, the MCU 106 responds with the SIP OK signal acknowledging that everything is in order. RTP media signaling is opened between the Client A 110a and the MCU 106 at 606. A similar exchange can be made between Client B 110b and the MCU 106. Again, an Invite request 608 from the Client B 110b is sent to the MCU 106, including the conference identifier. The MCU 106 responds at 610 with the OK signal, and an RTP media connection is opened at 611. The MCU 106 then mixes the conference for the Clients A and B.

To invoke recording, in the example illustrated, the recording server 104 is made a party to the conference. To do so, at 612, the MCU 106 issues a Refer command to the recording server 114. The Refer command identifies the conference and indicates that it is to be recorded. At 614, the recording server 114 responds with the SIP Invite request, and gets the OK response at 616. The recording server 114 will then receive a mixed media stream from the MCU 106 at 618.

Once the conference is established and the recording stream is being provided to the recording server, and stored as media files, the Client A 110a can access the recording. Thus, at 620, the Client A 110a can send a command to the recording server 114 and/or the MCU 106 requesting specific records, using a control interface such as the graphical user interface discussed above. At 622, the MCU 106 will then switch the output to the Client A from the real time mixed stream to the recorded stream 624, relayed from the recording server 106.

As noted above, according to one embodiment of the present invention, the recorded playback can occur in realtime, while conferencing among remaining parties to the conference is ongoing. For example, a user can select a beginning recording time and have the selection played back at a higher speed than initially recorded. The user can then rejoin the conference. In certain embodiments, the faster playback can be used to seamlessly return the user to the current time in the conference. This is illustrated schematically in FIG. 7. Shown is a real time timeline 702 and a recorded timeline 704. Timeline 702 shows times marked T, A, B, and C, representative of particular times during the conference. At time A, the client A can request a repeat of the TA period. This is shown played back at a high speed over TA′. Once the Client A has played back the desired portion of the conference, he can rejoin it, but will have missed the period marked 706 or AB. The Client A can again playback the AB portion 706 at a faster than recorded speed, so that he hears AB′, but will again have missed a portion of the conference. In practice, the user can select “Fast Forward”, to provide for speeded up playback until the recorded playback “meets” the realtime conference at C and C′.

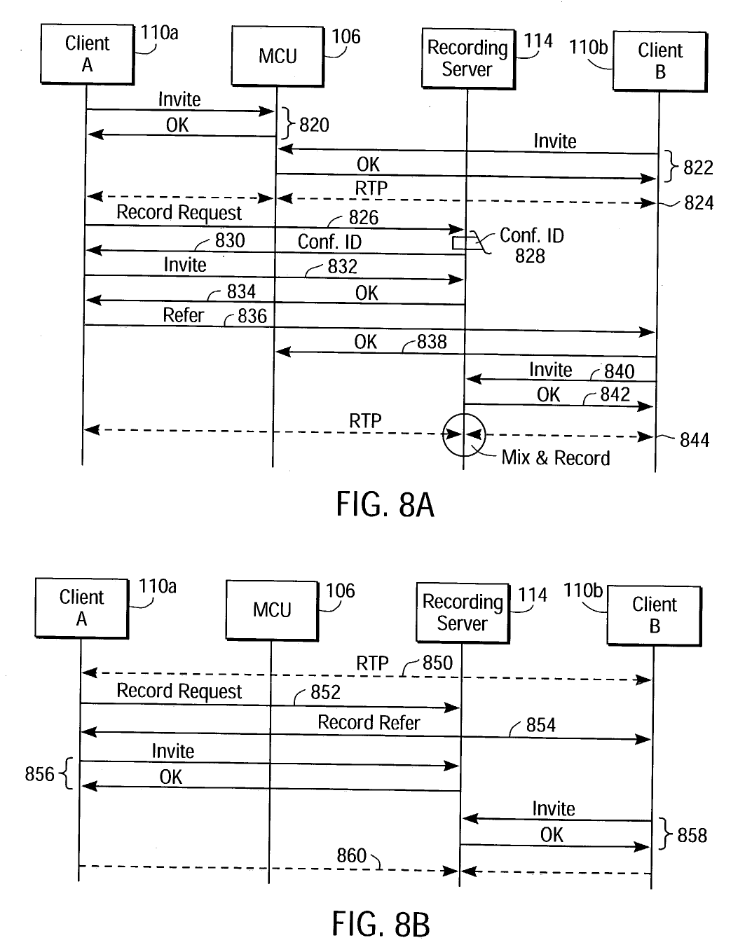

The recording server 114 may be brought into the conference in a variety of ways, for either two-party calls or multi-party conferences. One such method for multi-party conference recording has been discussed above with reference to FIG. 6. Other methods for recording two-party calls are discussed with reference to the signaling diagrams of FIG. 8A and FIG. 8B. It is noted, however, that other methods may be employed as well.

Turning now to FIG. 8A, a signaling diagram illustrating recording setup according to an embodiment of the present invention is shown. Shown are a client 110a, MCU 106, Recording Server 114, and client 110b. In this example, the recording server 104 itself can mix the audio and provide the recording, while call setup is made via the MCU 106.

At 820, the Client A sets up a conference with the MCU 106 using SIP Invite/OK exchange. Similarly, at 822, the Client B 110b sets up with its own Invite/OK exchange. The RTP media streams are mixed at the mixer in the MCU 106 at 824. At 826, the Client A 110a can send a record request to the recording server 106. At 828, in response, the recording server 114 can generate a conference identifier and provide it to the Client A 110a at 830. The Client A 110a then sends a SIP Invite signal to the recording server 114 at 832. The Invite includes the conference identifier. Once the OK is received at 834, the Client A 110a can send a Refer signal to the Client B 110b, at 836, which then responds with an OK at 838. The Client B 110b then undertakes the SIP Invite/OK exchange with the recording server 104, at 840/842. The Invite includes the conference identifier. Finally, at 844, the clients drop their connections via the MCU 106 and now take then up with the recording server.

Turning now to FIG. 8B, a signaling diagram illustrating recording setup according to an embodiment of the present invention is shown. In particular, shown is conference recording for a two-party call that does not use the MCU 106. Shown are a client 110a, MCU 106, Recording Server 114, and client 110b. In this example, the recording server 114 requests a duplicate media stream from each conference participant and mixes the recording.

As shown at 850, a media stream is provided between the client A 110a and the Client B 110b. That is, the parties are participating in a two-party conversation without the MCU 106. It is noted that, in other embodiments, more than two parties may participate in a conference without MCU 106 performing mixing; in such embodiments, one or more of the endpoints can do the mixing. To initiate recording, the Client A 110a sends a Record request to the recording server 114 at 852. The Record request can include an identifier of the parties whose conversation is to berecorded. At 854, the recording server 114 sends a “record refer” signal to the clients, which includes one or more identifiers indicating that a recording session is being requested. The Record Refer request is similar to a Refer, but also indicates that the clients are to provide duplicate signaling to the recording server. The clients receive the Refer requests and then undertake Invite/OK exchanges with the recording server 114 at 856/858. Finally, at 860, the clients provide duplicate streams to the recording server 114 for mixing and recording.

The invention described in the above detailed description is not intended to be limited to the specific form set forth herein, but is intended to cover such alternatives, modifications and equivalents as can reasonably be included within the spirit and scope of the appended claims.

What is claimed is:

1. A telecommunications method, comprising:
mixing media streams received from two or more parties to a conference at a conferencing server;
providing a recording stream to a recording server for recording the conference; and
selectively accessing recorded portions of the conference at said recording server while said conference is ongoing.

2. A telecommunications method in accordance with claim 1, wherein said selectively accessing comprises switching between a real-time media stream and a recorded media stream from said recording server.

3. A telecommunications method in accordance with claim 2, wherein said conferencing server is a telephony over local area network conferencing server.

4. A telecommunications method in accordance with claim 3, wherein said recorded media stream is a Real Time Protocol stream.

5. A telecommunications method in accordance with claim 1, wherein said selectively accessing comprises playing back a portion of a recorded stream at a higher speed than it was recorded.

6. A telecommunications system, comprising:
a conferencing server adapted to mix one or more conferencing streams;
a recording server operably coupled to said conferencing server and adapted to receive a mixed stream from said conferencing server; and
one or more telephony clients adapted to conference via said conferencing server, at least one of said one or more telephony clients including a recording user interface for controlling access to said recording server for switching between recorded playback and live playback during an ongoing conference.

7. A telecommunications system in accordance with claim 6, further comprising a local area network.

8. A telecommunications system in accordance with claim 7, wherein said recorded stream comprises a Real Time Protocol (RTP) stream.

9. A telecommunications system in accordance with claim 8, wherein said recording user interface is adapted to control a playback speed of said recorded playback.

10. A telecommunications system in accordance with claim 7, wherein said recording server includes a memory for storing one or more digital media fiels of recorded conversations.

11. A telecommunications system, comprising:
a plurality of telephony clients; and
a recording server operably coupled to record a conversation among said plurality of telephony clients;
wherein at least one of said plurality of telephony clients includes a recording user interface for controlling access to said recording server for switching between recorded playback and live playback during an ongoing conference.

12. A telecommunications system in accordance with claim 11, including a conferencing server including a mixer and adapted to set up a conference between said plurality of telephony clients and said recording server.

13. A telecommunications system in accordance with claim 11, wherein said recording server includes a mixer and is adapted to receive requests from at least one of said plurality of telephony clients to record a conference; said recording server further adapted to request parties to a conference to redirect their media streams to said recording server for said recording.

14. A telecommunications system in accordance with claim 11, wherein said recording server includes a mixer and is adapted to receive requests from at least one of said plurality of telephony clients to record a conference; said recording server further adapted to request parties to a conference to provide duplicate media streams to said recording server for said recording.

15. A telecommunications device, comprising:
a telephony client adapted to supervise the making of telephone calls; and
a recording client adapted to access a recording server to supervise recording of said telephone calls.

16. A telecommunications device in accordance with claim 15, wherein said telephony client is an Internet Protocol telephony client.

17. A telecommunications device in accordance with claim 16, wherein said recording client is adapted to alternately select live playback of said telephone calls and recorded playback of said telephone calls while one of said telephone calls is ongoing.

18. A telecommunications device in accordance with claim 17, wherein said recorded playback comprises playing back at a speed higher than a recorded speed.

19. A telecommunications device in accordance with claim 18, wherein said telephony client is adapted to supervise playback via a Real Time Protocol (RTP) stream.
